(19) United States
(12) Patent Application Publication
(10) Pub. No.: US 2002/0007279 A1
(43) Pub. Date: Jan. 17, 2002

(54) Multilingual document preparing method and multilingual document reading system

(76) Inventors: Mitsuhiro Matsuda, Kawasaki (JP); Shoko Matsushita, Yokohama (JP); Akihiro Date, Yokohama (JP)

Correspondence Address: TOWNSEND AND TOWNSEND AND CREW, TWO EMBARCADERO CENTER, EIGHTH FLOOR, SAN FRANCISCO, CA, 94111-3834, US

(21) Appl. No.: 09/797,484

(22) Filed: Feb. 28, 2001

(30) Foreign Application Priority Data
Apr. 13, 2000 (JP) 2000-117190

(51) Int. Cl. G10L 21/00

(52) U.S. Cl. 704/277

(57) ABSTRACT

Each of a plurality of standard sentences is beforehand prepared in a plurality of languages and managed as a database in which they are made to correspond to each other. A standard sentence specified by the user from among the plurality of sentences is displayed, so that in response to a translation instruction for translation into a language specified by the user from among the plurality of languages, a standard sentence written in the specified language which corresponds the above-mentioned specified standard sentence is retrieved in the database and then displayed at the terminal.

### BACKGROUND OF THE INVENTION

The invention relates to a method for preparing/reading documents of the same contents in a plurality of languages and a system for providing services of permitting documents of the same contents to be prepared/read in a plurality of languages. More specifically, the invention relates to a multilingual document preparing method and a multilingual document reading system for enabling documents prepared in one language to be displayed immediately and accurately in a plurality of other languages over various areas having different languages and interconnected by the Internet or any other globally developed communication networks.

With the recent expansion of the Internet and other communication networks developed globally, it has been essential to exchange information between areas with different languages and transmit the same information to a plurality of areas having different languages. To do so, it is necessary for an information transmitter beforehand to use translation technologies in order to thereby translate relevant documents into a language used in a reading side area or for the reading side to translate the documents into their own language.

The background art translation technologies may include, for example, machine translation, parallel-translated example sentence utilization translation, and template utilization translation. By machine translation, each of the sentences of a document is analyzed in terms of syntax and disassembled into a plurality of elements. Thus disassembled elements are then translated and assembled based on predetermined rules. By parallel-translated example-sentence utilization translation, for each of the sentences of a document, many side-by-side example sentences of translations and original texts called parallel-translated corpora are beforehand stored, which are then modified by a document implementor to thereby obtain translated sentences.

By template utilization translation, a document implementor inputs original texts in an original language. Then, the translation system converts noun-phrase equivalents of thus input original texts into variable symbols. The other portions are selected by the translation system as parallel-translated templates expressed in a target language. Then, the translation system translates thus variable-symbolized portions using a conventional machine translation method and combines this translation result with the selected parallel-translated templates to generate translated sentences. This template translation approach is disclosed in JP-A-03-116273.

JP-A-11-85753 also discloses therein a method for combining standard sentences to thereby convert original-language documents into target-language documents. By this method described in JP-A-11-85753, however, an original language is once converted into an intermediate language corresponding thereto, which is then converted into the target language. Thus, this method requires conversion twice.

Thus, the conventional translation technologies require aid in translation by a machine or man power when documents are translated. Specifically, it is necessary for the transmitter side to translate the documents in a plurality of languages or the reader side to translate them by means of interpretation by those other than their implementor. The recent communication networks globally developed has become to require for their operation the electronic commerce as well as immediate transmission and exchange of accurate information between different languages. Furthermore, it has been desired to employ a translation means using no man power.

For example, the securities business circles have globalized their stock exchange markets so that investors can stocks of the enterprises of any countries. Therefore, the materials in corporate IR (Investor Relations) activities and the disclosed documents such as important information papers or financial reports influencing the stock markets need to be fairly and immediately opened to the investors all over the world in their various languages. However, this is impossible by translation by means of man power. Machine translation has also been problematical in terms of real-time accessibility and accuracy.

### SUMMARY OF THE INVENTION

It is an object of the invention to provide a method for effectively and rapidly preparing multilingual documents and a multilingual document reading system for permitting the reader to easily read thus prepared multilingual documents.

The invention does not cause the document implementor to translate each of sentences but selects sentences which have beforehand been standardized. Those standardized sentences correspond to different languages and so can be rapidly and effectively translated into any other languages.

This object can be achieved by a document preparing method, and a device for implementing this method, that prepares each of a plurality of standard sentences in a plurality of languages beforehand and uses a managing database in which those sentences are made to correspond to those languages, to display a user-specified ones of those sentences, so that when an instruction is received for translation into a user-specified one of the above-mentioned plurality of languages, this user-specified language is retrieved from among the plurality of languages to which the above-mentioned specified sentence corresponds to thereby display this specified sentence in it.

This object can be achieved also by a document preparing service providing system, and a method for providing document preparing services by use of the system, that comprises a means for registering a plurality of standard documents corresponding to a plurality of languages, a standard-document managing database for managing this plurality of standard documents, a means for, in response to an instruction from a user, providing a standard document which corresponds to one of the plurality of languages from the standard-document managing database, and a means for, in response to a translation instruction to this standard document from the user, providing another document which corresponds to a language different from the above-mentioned one language from the standard-document managing database.

In this system, the above-mentioned sentence may have a variable portion that can be changed by the user besides a fixed portion which is beforehand made to correspond to a plurality of languages.

Note here that to achieve the above-mentioned object, the system may be a program for achieving the above-mentioned functions or a storage medium that stores this program thereon.

### BRIEF DESCRIPTION OF THE DRAWINGS

FIG. 1 is a functional block diagram of a multilingual document preparing system according to the invention;

FIG. 2 is a block diagram of one embodiment of the multilingual document preparing system according to the invention;

FIG. 3 is a flowchart explaining the operations of the multilingual document preparing system of FIG. 3;

FIG. 4 is a continued flowchart explaining the operations of the multilingual document preparing system of FIG. 3;

FIG. 5 is a schematic diagram explaining the operations of a client in the multilingual document preparing system of FIG. 3;

FIG. 6 is a selecting/inputting form of standard-sentence utilization forms for the multilingual document preparing system of FIG. 3;

FIG. 7 is a parameter inputting form of the standard-sentence utilization forms for the multilingual document preparing system of FIG. 3;

FIG. 8 is a multilingual sentence managing table of the multilingual document preparing system of FIG. 3; and

FIG. 9 is a registered-document managing database and a registered-document variable managing database of the multilingual document preparing system of FIG. 3.

### DESCRIPTION OF THE EMBODIMENTS

The following will describe one embodiments of the invention with reference to the drawings.

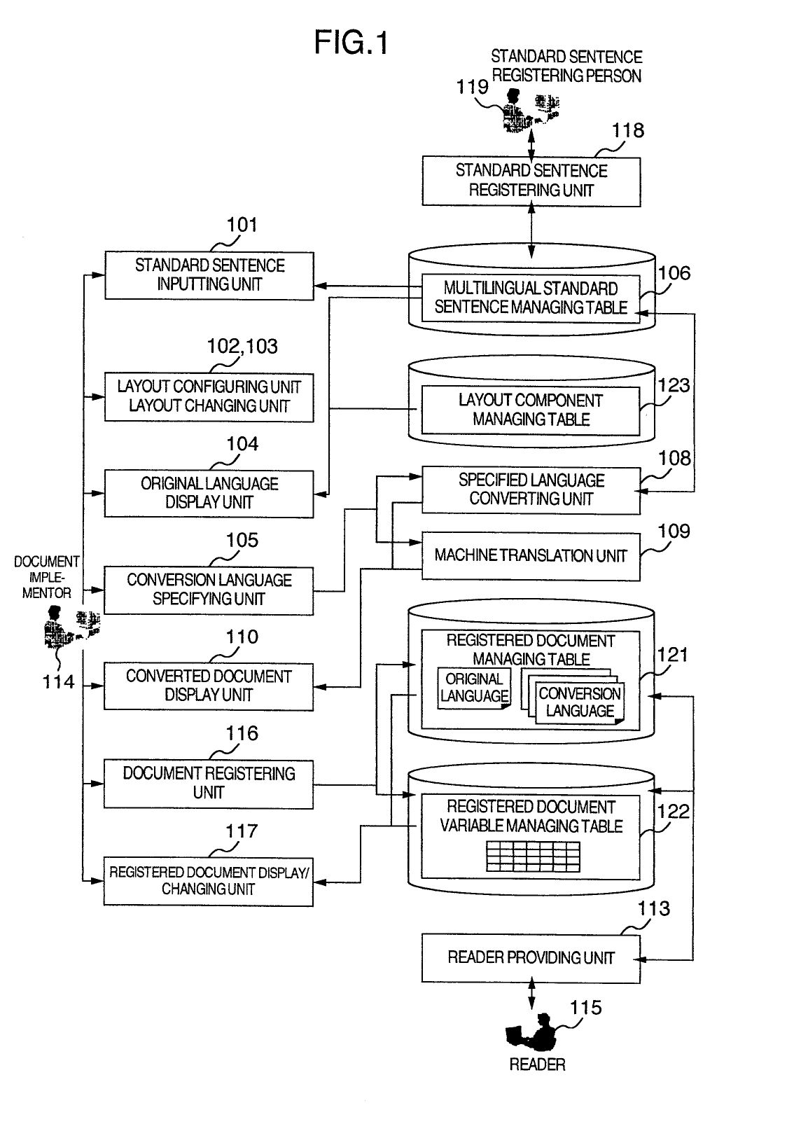

FIG. 1 is a functional configuration example of a multilingual document preparing system according to the invention. This multilingual document preparing system according to the invention comprises a standard document acquiring unit 101 having a selection function of selecting a standard sentence in order to acquire a sentence standardized by a document implementor 114 and a function for inputting a variable portion, if any, of a standard sentence, an layout configuring unit 102 for permitting the implementor 114 to design an layout of a document, a layout-changing unit 103 for changing an layout configured by the layout configuring unit 102, and a layout-component managing table 123 for managing layout components such as graphs used in the layout configuration.

Furthermore, the multilingual document preparing system comprises an original language display unit 104 for display in an original language of the implementor a standard sentence selected by the unit 101 or a graph obtained as a layout component from the layout component managing table and a conversion language specifying unit 105 having a function permitting the implementor 114 to specify a language to be converted and a function for transferring information of thus specified conversion language and a standard sentence selected by the standard document acquiring unit 101 to a specified language converting unit 108 or an input variable portion, if any, of a standard sentence to a machine-translation unit 109.

The multilingual document preparing system comprises also a multilingual standard sentence managing table 106 including a correspondence table for corresponding of multilingual standard sentences and a managing table for managing variable information, a specified-language converting unit 108 having a function for using the multilingual sentence managing table to thereby convert a standard sentence transferred from the conversion language specifying unit 105 into a specified language based on conversion-specified language information transferred from the conversion language specifying unit 105, and a machine translation unit 109 for machine-translating a variable transferred from the conversion language specifying unit 105 into a specified language based on conversion-specified language information transferred from the conversion language specifying unit 105.

The multilingual document preparing system comprises also a converted-sentence display unit 110 for displaying a standard sentence which is converted by the specified-language converting unit 108 and a variable which is machine-translated by the machine translation unit 109 according to the above-mentioned layout configuration, a document registering unit 116 having a function for permitting the implementor 114 to register an original language document and a converted document and also the accompanied information in a registered document managing table 121 and a registered document variable managing table 122, a registered document managing table 121 for managing a document registered by the document registering unit 116 and the accompanied information, and the registered document variable managing table 122 for managing a variable portion of a document to be registered by the document registering unit 116.

The multilingual document preparing system comprises also a registered-document display/changing unit 117 for permitting the implementor to display and change original language documents and converted documents registered in the registered document managing table 121 and the registered document variable managing table 122, a reader providing unit 113 for providing a reader 115 with reader-specified language sentences and variable data, and a standard-sentence registering unit 118 having a function for permitting a standard-sentence registering person 119 to register standardized sentences and make multilingual standardized sentences to correspond to various languages.

Those units may be provided in a form of programs for implementing them, which programs may also be distributed, for example, over the Internet or provided on CD-ROMs or any other storage media.

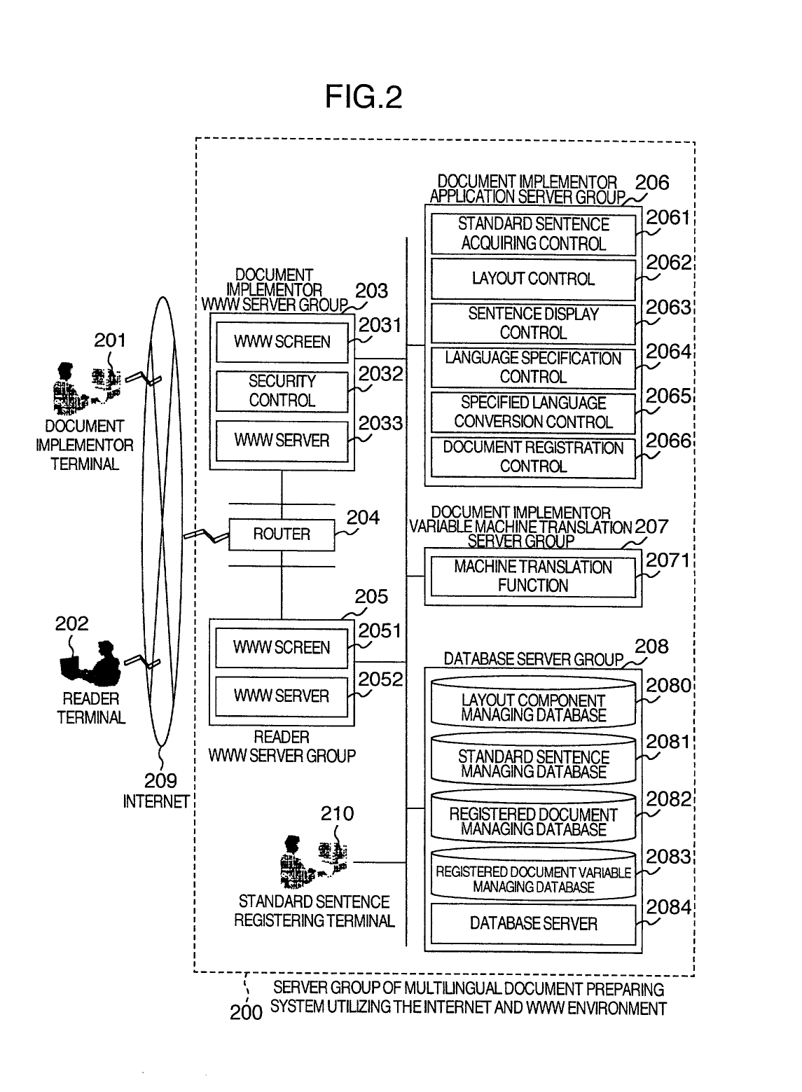

FIG. 2 shows a configuration example of an embodiment of a multilingual document preparing system which utilizes the Internet and the WWW environment. A server group 200 of the multilingual document preparing system communicates with a document implementor terminal 210 utilized by the implementor and a reader terminal 202 utilized by the reader over the Internet 209. Document preparing services are always provided using the server group 200.

The document preparing terminal 201 and the reader terminal 202 have such browser functions that enable acquiring, displaying, and execution of application views over the Internet 209. The server group 200 of the multilingual document preparing system comprises a document implementor WWW server group 203, a router 204, a reader WWW server group 205, a document implementor application server group 206, a document implementor variable machine translation server group 207, a database server group 208, and a standard sentence registering terminal 210 having the standard sentence registering unit 118 shown in FIG. 1.

The document implementor WWW server group 203 has a WWW screen 2031 for providing an application view, and control thereon, displayed at the terminal for permitting the document implementor to give at the document implementor terminal 201 various instructions to the standard sentence acquiring unit 101, the layout configuration unit 102, the layout changing unit 103, the original language display unit 104, the conversion language specifying unit 105, the converted document display unit 110, the document registering unit 116, and the registered document display/changing unit 117 which are shown in FIG. 1, a WWW server 2033, and a security control 2032 for checking the users.

The reader WWW server group 205 has a WWW screen 2051 for providing an application view, and control thereon, displayed at the terminal for permitting the reader to give at the reader terminal 202 various instructions to the reader acquiring unit 113 shown in FIG. 1 and a WWW server 2052.

The database server group 208 has an layout component managing database 2080 with the layout component managing table 123 shown in FIG. 1, a standard sentence managing database 2081 with the multilingual standard sentence managing table 106 shown in FIG. 1, a registered document managing database 2082 with the registered document managing table 121 shown in FIG. 1, and a registered document variable managing database 2083 with the registered document variable managing table 122 shown in FIG. 1, and a database server 2084 with a database management control function.

The document implementor application server group 206 has a standard sentence acquisition control 2061 which is an application for permitting the document implementor terminal 201 to control access to the standard sentence managing database 2081 from the application view of the standard sentence acquiring unit 101 shown in FIG. 1, a layout control 2062 which is an application for providing control required to provide layout components to the application view of the original document display unit 104 shown in FIG. 1 from the layout component managing database 2080 based on the information of a layout configuration of the layout configuring unit 102 and the layout changing unit 103 and the information of layout changes, and a document display control 2063 which is an application for providing control to transfer information required to display on the application view of the converted document display unit 110 shown in FIG. 1 the information required for document display from a specified language converting control 2065 and a machine translation function 2071.

The application server group 206 has also a language specification control 2064 which is an application for providing control to transfer to the specified language conversion control 2065 and the machine translation function 2071 the information of a specified language and the information of original language documents and variable from the application view of the conversion language specifying unit 105 shown in FIG. 1, the specified language conversion control 2065 which is an application for providing control to receive the information of a specified language from the above-mentioned language specification control 2064 and acquire standard sentences in the specified language from the standard sentence managing database 2081 and then transfer them to the document display control 2063, and a document registration control 2066 which is an application for providing control access to the registered document managing database 2082 and the registered document variable managing database 2083 for original language documents or converted documents from the application view of the document registering unit 116.

The document implementor variable machine translation server group 207 has a machine translation function which is an application for providing control to convert variables into a specified language transmitted from the language specification control 2064 using a conventional machine conversion/translation unit and then transfer thus converted variables to the document display control 2063.

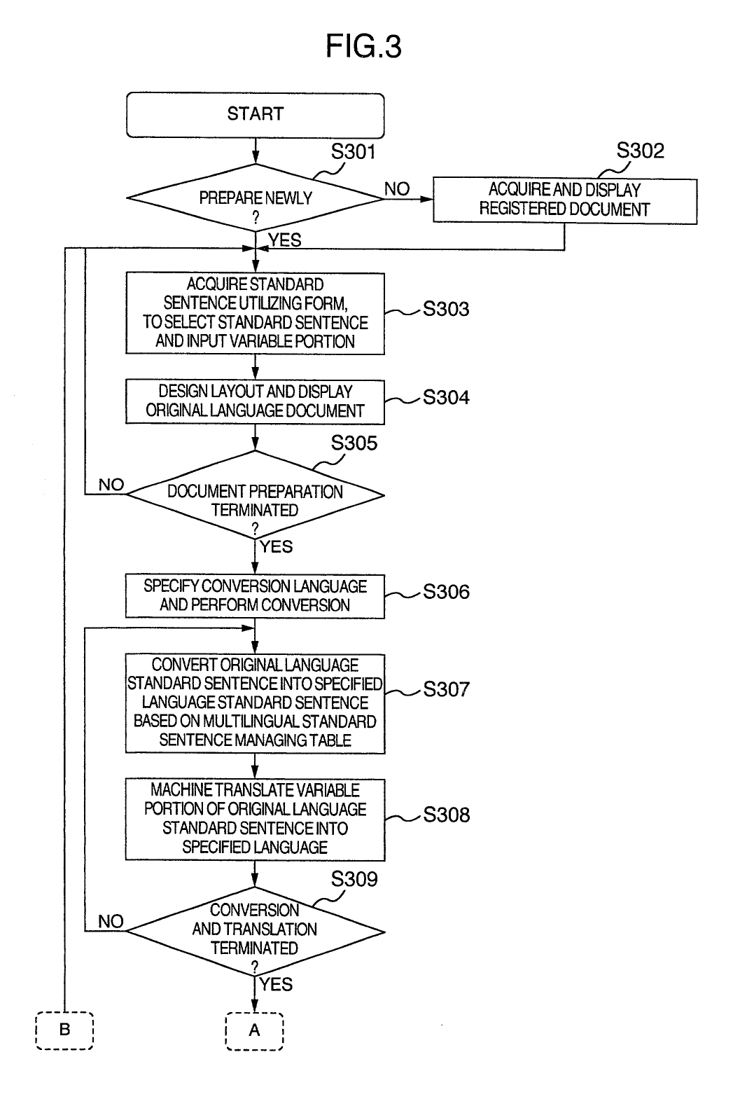

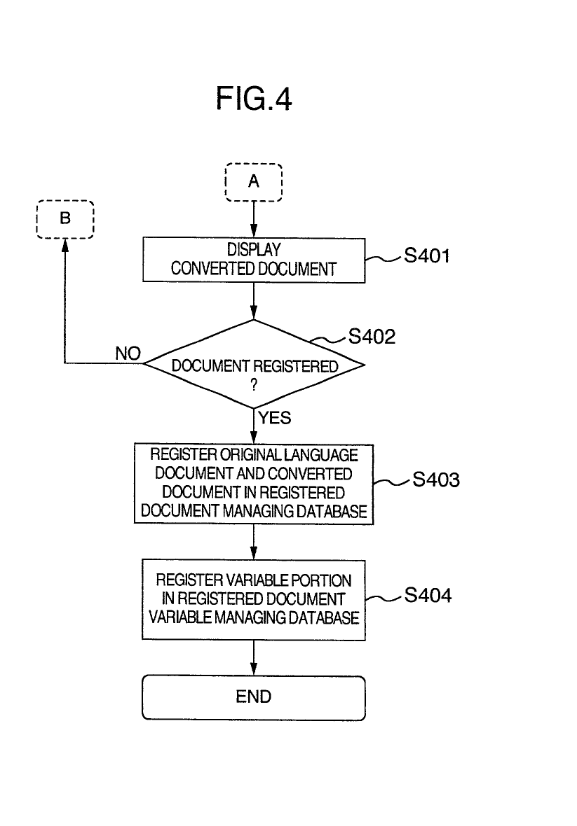

The following will describe the flow of processing by this embodiment with reference to flowcharts of FIGS. 3 and 4 and contents of FIGS. 1, 2, 5, 6, and 7.

The document implementor utilizes the document implementor terminal 201 shown in FIG. 2 to thereby connect to the document implementor WWW server 203, thus acquiring a client application view for the units 101-105, 110, 116, and 117 shown in FIG. 1.

In this embodiment, specifically, the application view according to this embodiment is acquired by utilizing the WWW screen.

First, the client application view is used to decide thereon whether a document is to be prepared newly (step S301).

To prepare or correct that document based on an already registered document, the client application view for the unit 117 is used to acquire that registered document from the registered document managing database 2082 and the registered document variable managing database 2083 in order to display it thereon (step S302).

Next, the client application view for the unit 101 is used to utilize the standard sentence acquisition control 2061 to thereby acquire a standard sentence utilization form required to prepare the document, thus inputting selection portions and variable portions (step S303).

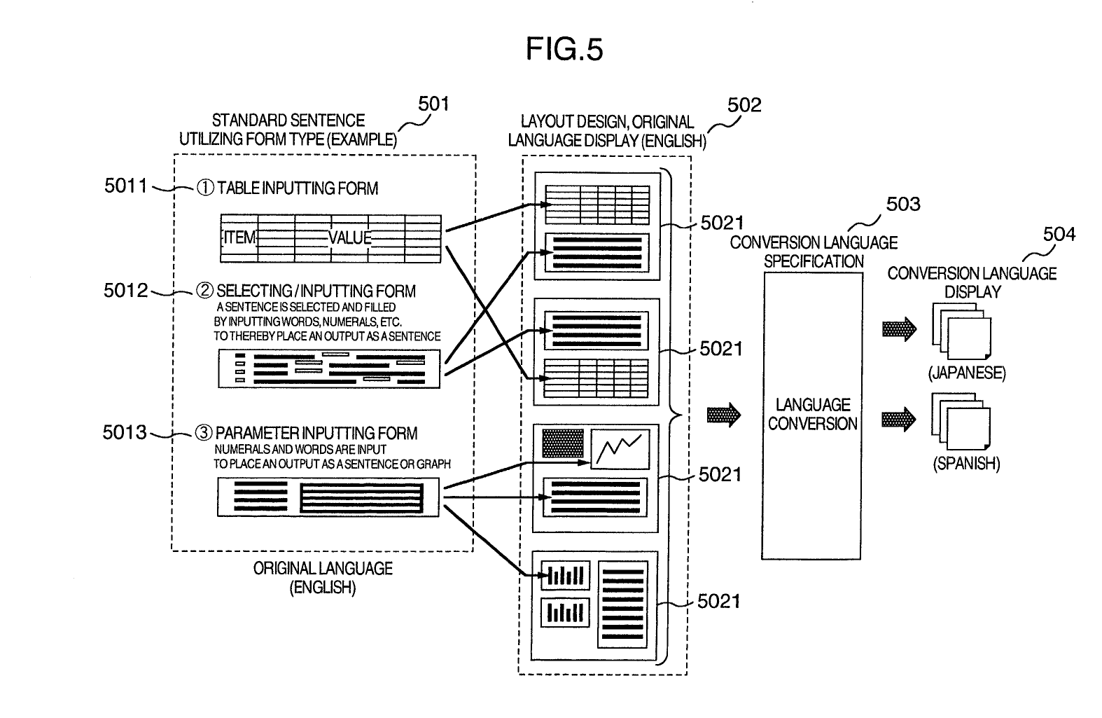

FIG. 5 shows a table inputting form 5011, a selecting/inputting form 5012, a parameter inputting form 5013 as a type example 501 of the standard document utilizing form. The table inputting form 5011 is a form example which lists the correspondence of standard sentence at table item portions to a plurality of languages so that the document implementor can input a numeral at a variable portion according to the item. The selecting/inputting form 5012 is a form example which employs a selection type of standard sentences so that the document implementor can input in a filling manner a word and a numeral at the variable portion. The parameter inputting form 5013 is such a form example that the document implementor can only input parameters of a word or a numeral at specified items to output sentences and graphs.

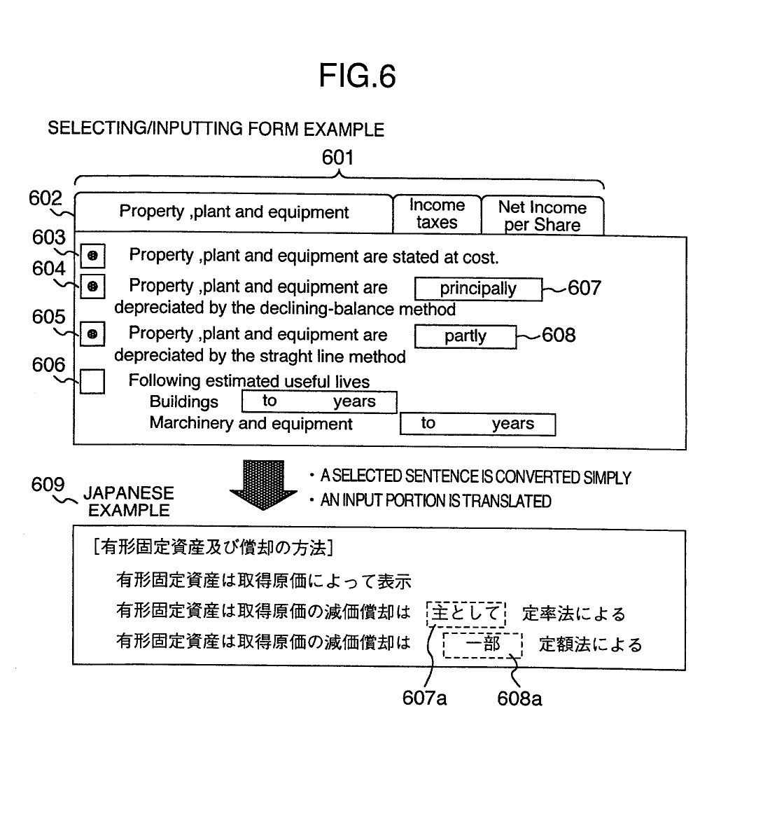

FIG. 6 shows a selecting/inputting form example in which the document implementor selects a standard sentence written in English and converts it into a Japanese equivalent. Specifically, the document implementor selects it from a selection item 601 in the paragraph-unit standard sentence group. In this example, he/she selects a “Property”, “plant and equipment” item 602 and then three standard sentences 603, 604, and 605. He/she has input “principally” at a variable portion of the standard sentence 604 and “partly” at a variable portion 608 of the standard sentence 605. This standard sentence and the variable portion can be converted in terms of language with the specified language conversion control 2065 and the machine translation function 2071 respectively into a Japanese equivalent example 609. In the Japanese example 609, a portion 607a is a Japanese equivalent of “principally” 607 and a portion 608a, a Japanese equivalent of “partly” 608.

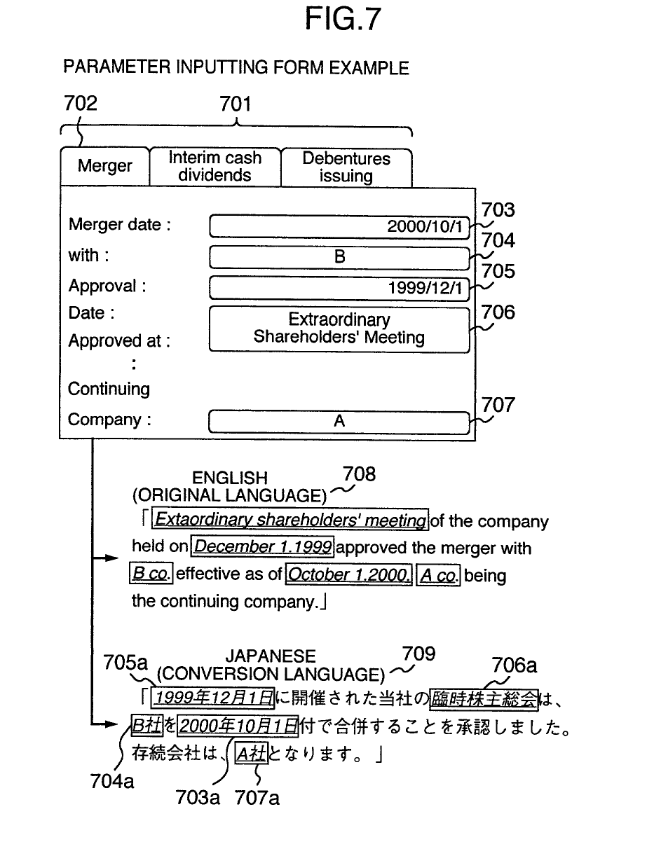

FIG. 7 shows a parameter inputting form example whereby a parameter is input using English as an original language for conversion into Japanese sentences. Specifically, the document implementor selects his/her desired target standard sentence from the selection item 701 of paragraph-unit standard sentences. In this example, he/she selects a Merger item 702 to input parameters of words or numerals at five specified items 703, 704, 705, 706, and 707. This is exemplified at 708 displayed in the original language and at 709 displayed in the converted language. In the Japanese sentence 709, portions 703a, 704a, 705a, 706a, and 707a are the Japanese equivalents of words or numerals input to specified items 703, 704, 705, 706, and 707 respectively. Thus, a sentence relating to Merger can be prepared.

After he/she has input the standard sentence utilizing form, the document implementor designs a layout and displays necessary contents in the original language on the client application view for the original language display unit 104 using the layout configuring unit 102 and the layout changing unit 103 shown in FIG. 1 (step S304).

In this embodiment, as shown in FIG. 5, the layout design/original language display 502 displays in an original language each inputting form in a document format 502 which is near an actual sentence so that the document implementor can easily check the sentence.

At step S305, the system decides whether document preparing jobs such as inputting of the standard sentence utilization form or designing of a layout have been terminated. In negative decision, the system repeats the inputting of a standard sentence utilization form (step S303) or the designing o a layout (step S304) until they are terminated, upon which control goes to step S306.

After he/she has completed the document preparing jobs such as standard sentence utilization form inputting and layout designing, the document implementor uses the client application view for the conversion language specifying unit 105 to specify thereon a conversion language and perform conversion (step S306).

When performing information is transferred from the client application view for the conversion language specifying unit 105 to the language specification control 2064, it then transfers that performing information to the specified language conversion control 2065. The specified language conversion control 2065 converts a standard sentence written in the original language into a specified language equivalent based on a multilingual standard sentence correspondence table (step S307).

As for a variable portion of the original language standard sentence also, when the performing information is transferred from the client application view for the conversion language specifying unit 105 to the language specification control 2065, it then transfers that performing information to the machine translation function 2071. The machine translation function 2071 translates the variable into the specified language (step S308).

At step S309, the language specification control 2064 decides whether all of the conversion and machine translation jobs have been terminated. In negative decision, the system repeats processing of the standard sentences and the variables yet to be completed (at steps S307 and S308 respectively) until they are completed, upon which control goes to the next step S401.

When the language specification control 2064 has terminated its jobs, the document display control function 2063 transfers a standard sentence group of variable converted and machine-translated to the client application view for the conversion document display unit 110. On this client application view, the document is displayed according to the layout configuration (step S401).

For example, as shown in FIG. 5, a conversion language specification 503 specifies a language to be converted and a conversion language display 504 displays two languages.

As shown in FIG. 4, the document implementor confirms thus displayed conversion language and decides whether the document is to be registered (step S402). If the document is to be corrected again, control returns to step S303 to input the standard sentence utilization form or re-design the layout and if it is to be registered, control goes to step S403.

The original language document and the converted sentence are registered in the registered document managing database 2082 and the registered document variable managing database 2083 using the client application view for the document registering unit 116 and the document registration control 2066 (step S403).

If the standard sentence has a variable portion, a variable portion at the table item is registered at the variable item of the registered document variable managing database 2083 in the case of, for example, the table inputting form 5011 shown in FIG. 5 (step S404).

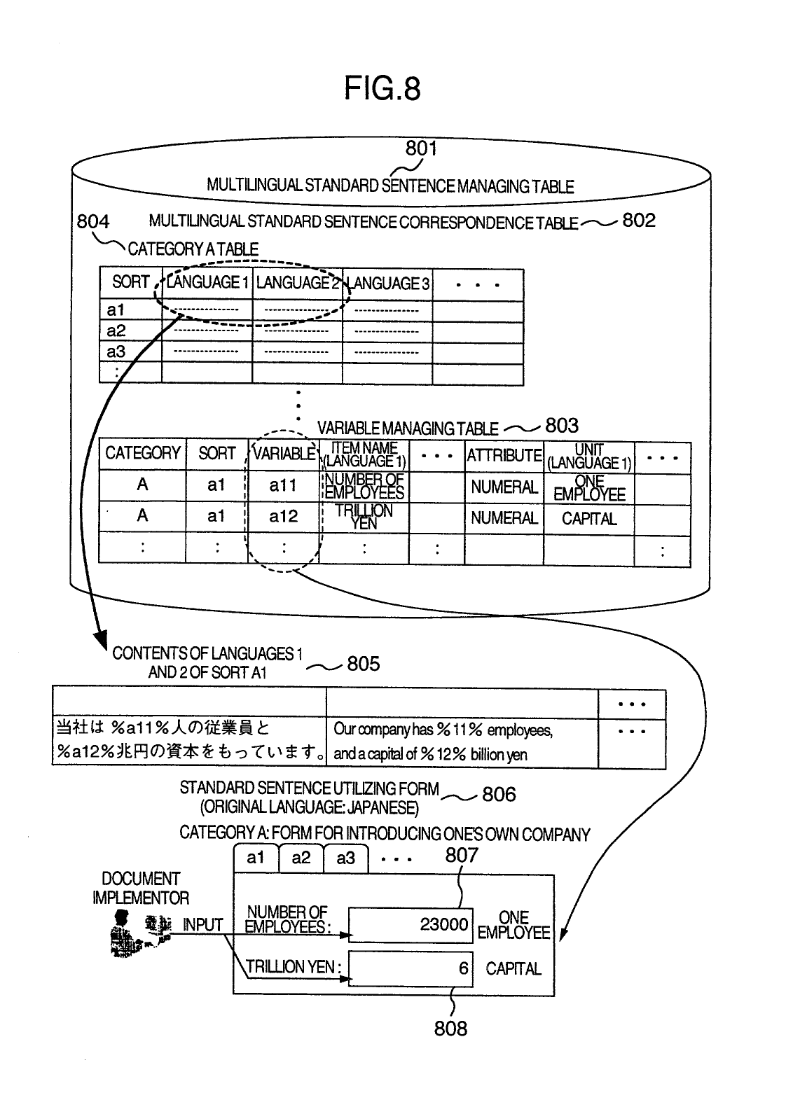

The following will describe the multilingual standard sentence managing table 106 in which standard sentences prepared and registered by the standard sentence registering person are listed and which is stored in the standard sentence managing database 2081 according to this embodiment using the multilingual standard sentence managing control unit 107, with reference to FIG. 8.

A multilingual standard sentence managing table 801 shown in FIG. 8 has a multilingual standard sentence correspondence table 802 and a variable managing table 803. The multilingual standard sentence correspondence table 802 has a category table for each category of standard sentences. For example, a category A table 804 stores therein standard sentences for introduction of the company of oneself, to each sort corresponding the standard sentences of languages 1 and 2 and other languages. A content 805 of languages 1 and 2 of a sort a1 is a figure showing the contents of the languages 1 and 2 of the sort a1 in the category A table 804. The sorts a1, a2; . . . , represent locations for storing standard sentences in the multilingual standard sentence managing table 801 and do not contain information directly related to the contents of the standard sentence. This is because multilingual sentences having the same contents are previously stored so as to correspond to each other in the same database, and hence the sort indicating information need not indicate the contents of the standard sentence.

The languages 1 and 2 of the sort a1 of the content 805 respectively store Japanese standard sentences and English ones having the same meaning. In an example of the standard sentence of the content 805 of the languages 1 and 2 of the sort a1, the language 1 stores [symbol] %a11% [symbol] %a12% [symbol] [symbol] and the language 2 stores “Our company has %a11% employees, and a capital of %12% billion Yen”, thus having a standard sentence example with variable portions. The symbol representing a variable portion in a standard sentence according to this embodiment is supposed to be %. The standard sentence example of the content 805 contains two variables a11 and a12.

The variable information of a11 and a12 is managed by the variable managing table 803. Which stores an item name, attribute, a unit, etc. of the variable in this embodiment. According to this embodiment, by using such a multilingual standard sentence managing table 801, the standard sentence utilization form 806 is prepared and displayed on the terminal screen as the parameter inputting form shown in FIG. 7 for use by the document implementor. The standard sentence utilization form shown in FIG. 8 is an example where the original language is Japanese, for inputting parameters of the sort a1 related to the oneself-company introduction in the category A table 804. Numerals 807 and 808 represent variable inputting portions. In the variable inputting portion 807, the item name represents the number of employees and the unit, a person. In the variable inputting portion 808, the item name represents a capital and the unit represents a column in which the amount is input in units of trillion (or billion), thus constituting a parameter inputting form based on the information from the variable managing table 803. Although the standard sentence according to this embodiment is exemplified by a standard sentence containing a variable and provided to the document implementor as a parameter inputting form, it may of course be provided otherwise based on the information from the multilingual standard sentence correspondence table 802 or the variable managing table 803.

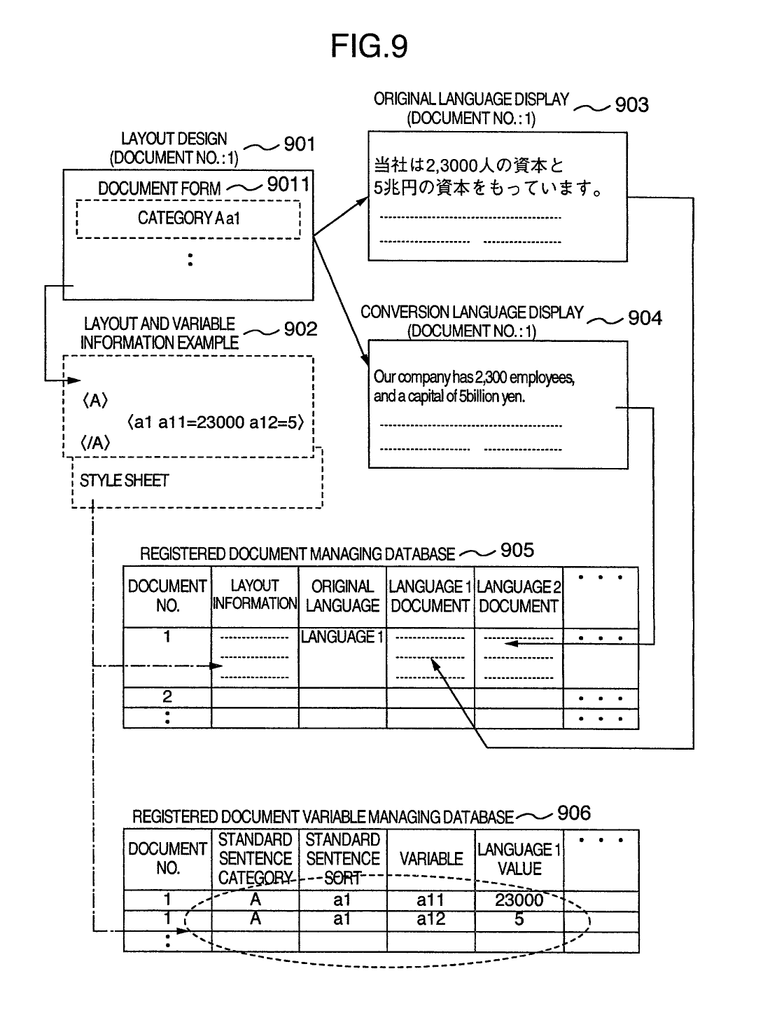

The following will describe a scheme for storing documents in the registered document managing database 2082 according to this embodiment using the document control unit 111 and a scheme for storing document variables in the document variable managing database 2083 using the variable control unit 112, with reference to FIG. 9.

FIG. 9 shows a procedure for storing in the registered document managing database 905 and the registered document variable managing database 906 an original language document 903, and a converted document 904 thereof, that is prepared by the document implementor according to, for example, the standard sentence utilization form 806. In this embodiment, the registered document managing database 905 has such items as document number, layout information, original language specification information of document implementor, and registered document, while the registered document variable managing database 906 has such items as document number, category and sort of standard sentence, and information of variable and value. The registered document managing database 905 and the registered document variable managing database 906 are related to each other by the document number.

To determine a document layout configuration, the document implementor layouts the standard sentence utilization form 806 into a document form 9011 for performing layout design 901. The information of this layout design 901 can be expressed by a method utilizing tags and a style sheet like in the case of the layout and variable information example 902, to thereby store the style sheet having the layout information at the item of the layout information in the registered document managing database 905. The variable information can be stored as expressed in tags in the registered document variable managing database 906. Furthermore, the original language document 903 and the converted document 904 are stored in the registered document managing database 905.

By employing such an approach to store and manage necessary contents in the registered document managing database and the registered document variable managing database, the reader can be immediately provided with the information of the language translated by the document implementor and the variables and by relating them to the multilingual standard sentence managing table, even those languages other than that converted by the document implementor can be provided.

Thus, according to the one embodiment of the multilingual document preparing system according to the invention, the document implementor can obtain from the server group 200 of the multilingual document preparing system those sentences to be components of a document as a standard sentence utilization form to thereby prepare a document based on this standard sentence utilization form, thus reducing the time required to prepare documents. Furthermore, by using the multilingual standard sentence managing table of the server group 200 of the multilingual document preparing system, it is possible to readily convert a sentence to a standard sentence written in any other language which corresponds to the standard sentence, thus reducing the time required in translation. Moreover, by using the server group 200 of the multilingual document preparing system to manage documents corresponding to a plurality of languages, much more multifarious documents can be managed than a case where the document implementor etc. separately manages standard sentences corresponding to a plurality of languages. Moreover, the information of newly prepared standard sentences etc. can also be shared and utilized, to provide higher quality services. In addition, translation by use of common information (standard documents etc.) is also possible, thus providing a plurality of readers with translations telling more accurate contents intended by the implementor.

Although the above-mentioned one embodiment according to the invention has been described with reference to the system example in the form of a WWW system, the invention can be applied to any other system form as far as a functional configuration shown in FIG. 1 is provided. Furthermore, in the standard sentence utilization form example, any other sentence selecting form may be possible such as sentence preparation by use of a questionnaire type. In this case also, of course, by providing a multilingual standard sentence managing table in which standard sentences are beforehand made to correspond to other languages, any inputting form can be applied. Furthermore, by providing the multilingual standard sentence managing table and the registered document and document variable managing databases, the reader side can select a conversion language, to enable such a system that the reader side can determine a conversion language while the document implementor prepares documents with only an original language in his/her mind.

1. A document preparing method employing a database which manages a plurality of standard sentences by beforehand preparing each of said plurality of standard sentences in a plurality of languages to create a plurality of standard sentences in different languages derived from each of said standard sentences, said method comprising the steps of:
displaying at a user terminal a standard sentence specified by the user from among said plurality of standard sentences;
receiving a translation instruction for translation into a language specified by the user from among said plurality of languages, to retrieve in said database a standard sentence written in said specified language to which standard sentence said specified standard sentence corresponds; and
displaying said standard sentence thus retrieved in said specified language.

2. The document preparing method according to claim 1, wherein said standard sentence has, in addition to a fixed portion which is beforehand prepared to correspond to said plurality of languages, a variable portion that is changeable by the user when he/she is preparing a document.

3. A computer readable storage medium storing a document preparing program which executes said document preparing method according to claim 1.

4. A document preparing service providing system comprising:
means for registering a plurality of standard documents, each of said standard documents being prepared in a plurality of languages and then registered;
a standard document managing database for managing said standard documents so that standard documents having a same content but different languages correspond to each other;
means, responsive to an instruction from a user, for providing a standard document which corresponds to one language of said plurality of languages from among said standard document managing database; and
means, responsive to a translation instruction for said standard document from the user, for providing a standard document which corresponds to a language different from said one language from among said standard document managing database.

5. The document preparing service providing system according to claim 4, wherein:
said standard document has, in addition to a fixed portion which is beforehand prepared to correspond to a plurality of languages, a variable portion that is changeable by the user; and
said system comprises a database for managing a translation result of said variable portion.

6. A method for preparing a document in one language and preparing a document in another language by translating each of a plurality of standard sentences in said one language into a plurality of standard sentences in other languages and relating standard sentences having a same content but in different languages to each other to utilize a set of thus mutually related sentences on a computer, comprising the steps of:
when a document implementor prepares a document in a language, selecting at an implementor side terminal a standard sentence written in said one language from among said set;
repeating said selecting step to prepare a document;
converting standard sentences thus selected constituting said prepared document into standard sentences in said another language specified by said implementor using said set;
repeating said converting step to prepare a document in said another language; and
if said implementor specifies still another language, repeating said document preparing method to prepare a document in said still another language.

7. A multilingual document preparing device comprising:
a set of standard sentences obtained by translating each of a plurality of standard sentences into a plurality of languages to create standard sentences in different languages derived from each of said standard sentences;
means responsive to specification from a document implementor, for selecting a standard sentence stored in said set;
means for collecting said standard sentences thus selected to form a document; and
means for converting said standard sentences thus selected into corresponding standard sentences written in a language specified by said implementor based on said set.

8. A method for preparing a document in one language and preparing another document in another language based on said prepared document by separating a standard sentence of said prepared document into a fixed portion and a variable portion (hereinafter called “a variables”) and translating said fixed portion of said standard sentence into a plurality of languages to create fixed portions of said standard sentence having a same content but in different languages, relate said translated fixed portions of a same standard sentence to each other and also relate position information and attribute information of said variable of the same standard sentence to each other in order to utilize a set of said standard sentences thus related on a computer, comprising the steps of:
when a document implementor prepares a document in one language, selecting at an implementor side terminal a standard sentence written in said one language from among said set;
inputting a value into a variable related to said standard sentence;
preparing a sentence using said input variable and a fixed portion of said standard sentence thus selected as well as said position information of said variable;
repeating said standard sentence selecting step, said value inputting step, and said sentence preparing step to prepare said document;
utilizing a set of prepared sentences constituting said prepared document to thereby convert a fixed portion of each of said selected standard sentences into a fix portion of a corresponding standard sentence written in another language specified by the implementor;
machine translating said variable of each of said selected standard sentence into said another language specified by the implementor;
preparing a target sentence using said converted fixed portion and said machine translated variable;
repeating said utilizing and converting step and said sentence preparing step to prepare a target document written in the another language; and
if the implementor specifies still another language, repeating said repeating and preparing step to prepare still another target document in said still another language.

9. A multilingual document preparing device by utilizing a set of standard sentences obtained by separating a standard sentence into a fixed portion and a variable portion (hereinafter called “a variables”) and translating said fixed portion of said standard sentence into a plurality of languages to create fixed portions of said standard sentence having a same content but in different languages, relate said translated fixed portions of a same standard sentence to each other and also relate position information and attribute information of said variable of the same standard sentence to each other, thus collecting the related sentences, comprising:
means for permitting a document implementor to select a standard sentence stored in said set;
means for inputting a value into a variable related to said selected standard sentence;
means for preparing a sentence using said input value and fixed portion of the standard sentence thus selected as well as said position information of said variable;
means for collecting a plurality of the prepared sentences to form a document;
means for separating a prepared sentence into the fixed portion and the variable;
means for converting the separated fixed portion into a fixed portion of a target sentence written in another language specified by the implementor;
means for machine translating the separated variable into said another language specified by the implementor; and
means for preparing a target document using said converted fixed portion and said machine translated variable for each of the prepared sentences.

10. The multilingual document preparing method according to claim 8, wherein said input variables and said attribute information thereof are saved in a table so that in response to a request from the implementor, at least one of the variables and the attribute information thereof are provided.
